(19) United States
(12) Patent Application Publication
(10) Pub. No.: US 2024/0316980 A1
(43) Pub. Date: Sep. 26, 2024

(54) CARD SYSTEM

(71) Applicant: LOVEPOP, INC., Boston, MA (US)

(72) Inventor: Xinzhi Jiao, Boston, MA (US)

(21) Appl. No.: 18/615,967

(22) Filed: Mar. 25, 2024

Related U.S. Application Data
(63) Continuation-in-part of application No. 29/887,564, filed on Mar. 22, 2023.
(60) Provisional application No. 63/454,409, filed on Mar. 24, 2023.

(51) Int. Cl. B42D 15/04

(52) U.S. Cl. CPC B42D 15/045

(57) ABSTRACT

Implementations described and claimed herein provide a card system. In one implementation, includes a plurality of cards in an enclosed relationship. At least one of the plurality of cards includes a pocket configured to respectively receive a corresponding card of the plurality of cards.

### CROSS-REFERENCE TO RELATED APPLICATIONS

The present application is a continuation-in-part of U.S. Design patent application Ser. No. 29/887,564 filed on Mar. 22, 2023. The present application claims priority to U.S. Provisional Patent Application No. 63/454,409 filed on Mar. 24, 2023. Each of these applications is incorporated by reference in its entirety herein.

### FIELD

The present application relates generally to card systems and, more particularly, to a system including a plurality of cards arranged in an enclosed relationship while maintaining a compact system profile.

### BACKGROUND

Cards, such as, for example, greeting cards, holiday cards, posters, books, or the like, typically include a single card with a message and/or content disposed thereon. It is with these observations in mind, among others, that various aspects of the present disclosure were conceived and developed.

### SUMMARY

Implementations described and claimed herein address the foregoing by providing systems and methods for presenting a card system. Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 shows an assembled, perspective view of an example card system.

FIG. 2 shows a first exploded, perspective view the card system of FIG. 1.

FIG. 3 shows a second exploded, perspective view the card system of FIG. 1.

FIG. 4 shows a perspective view of a first card of the card system of FIG. 1.

FIG. 5 shows a perspective view of a second card of the card system of FIG. 1.

FIG. 6 shows a perspective view of a third card of the card system of FIG. 1.

FIG. 7 shows a perspective view of a fourth card of the card system of FIG. 1.

FIG. 8 shows a perspective view of an example first card of a card system.

FIG. 9 shows a front view of the first card of FIG. 8.

FIG. 10 shows a back view of the first card of FIG. 8.

FIG. 11 shows a top view of the first card of FIG. 8.

FIG. 12 shows a first side view of the first card of FIG. 8.

FIG. 13 shows a second side view of the first card of FIG. 8.

FIG. 14 shows a bottom view of the first card of FIG. 8.

FIG. 15 shows a flow chart illustrating a method for presenting a card system.

FIGS. 16-22 show various example card systems with different example decorative portions. FIGS. 23-25 shows another example card system in a plurality of positions.

### DETAILED DESCRIPTION

Aspects of the presently disclosed technology relate to a card system. In some aspects, the card system includes a plurality of cards arranged in an enclosed relationship. At least one of the plurality of cards includes a pocket configured to respectively receive the remaining card(s) in a descending order corresponding to size with parent cards being larger in size than child cards. In one non-limiting example, the card system includes a first card including a first card pocket, a second card including a second card pocket, a third card including a third card pocket, and a fourth card, with the second card being sized smaller than the first card, the third card being sized smaller than the second card, and the fourth card being sized smaller than the third card. As such, the first card is a primary parent card with each of the second card, the third card, and the fourth card being its respective child cards. The second card is a parent card to the third and fourth card, and the third card is a parent card to the fourth card, which is a primary child card. The fourth card may have a plurality of panels or be formed as a single panel (e.g., a notecard). In this example, the first card pocket is configured to receive the second card, the second card pocket is configured to receive the third card, and the third card pocket is adapted to receive the fourth card. In such an enclosed relationship, the third card pocket encloses the fourth card in a first enclosed assembly, the second card pocket encloses the third card and the fourth card in a second enclosed assembly, and the first card pocket encloses the second card, the third card, and the fourth card in a third enclosed assembly. The third enclosed assembly forms a compact profile that may be sized to be received within an envelope corresponding to the dimensions of the first card. While this example and other examples provided herein depict a certain number of cards and relationships between those cards, it will be appreciated that any number of cards may be used in the card system and deployed in an enclosed relationship. For example, the card system may include a first card with a first pocket configured to receive a second card. In other examples, the card system may have three, four, five, six, and so on total cards in an enclosed relationship. In the various arrangements, there may be a primary parent card and a primary child card. In some implementations, there may be at least one additional parent card. The additional parent card(s) may form a series of enclosed assemblies according to a descending order in size. For example, the additional parent card(s) may include a first parent card and a second parent card, with the second parent card having a parent relationship with the primary child card and a child relationship with the first parent card, the first parent card having a child relationship with the primary parent card. The parent relationship may indicate a configuration to receive an enclosed assembly in a pocket, while the child relationship may indicate a configuration to form an enclosed assembly for receipt in a pocket. The parent relationship may correspond to a relatively larger sized card, while the child relationship may correspond to a relatively smaller sized card. As illustrated in the Figures, the cards of the card system may further include various ornamental features.

The technology disclosed herein generally provides for card structure systems. The example implementations discussed and illustrated herein reference a card system. However, it will be appreciated by those skilled in the art that the presently disclosed technology is applicable to other types of structures, including, but not limited to, posters, books, holiday cards, greeting cards, and/or the like. Additionally, various aspects of the present technology may be incorporated into integrated systems. For example, the card system may be incorporated into or otherwise pop-up display(s). Such displays may be formed from a plurality of slice-form elements configured to move between an erected state in three-dimensions (3D) and a flattened state as corresponding card panels move between an open position and closed position, respectively. In some examples, one or more of the cards in the card system may include a pop-up display mounted (removably or fixed) to at least one interior surface of the card, such that opening the card to the open position moves the pop-up display to the erected state and closing the card to the closed position moves the pop-up display to the flattened state. In the flattened state and closed positions, the pop-up display is sandwiched in the interior of the card between a first side and a second side and the card is configured for receipt into a pocket of a corresponding parent card. The primary parent card may include a pop-up display. In one example, a parent card may include a fold line separating a first side and a second side. The second side may include an interior panel on an interior side of a pocket formed by a first panel and a second panel. The interior panel may be configured to receive and cover at least one tab of the pop-up display. It will be appreciated that various configurations are contemplated.

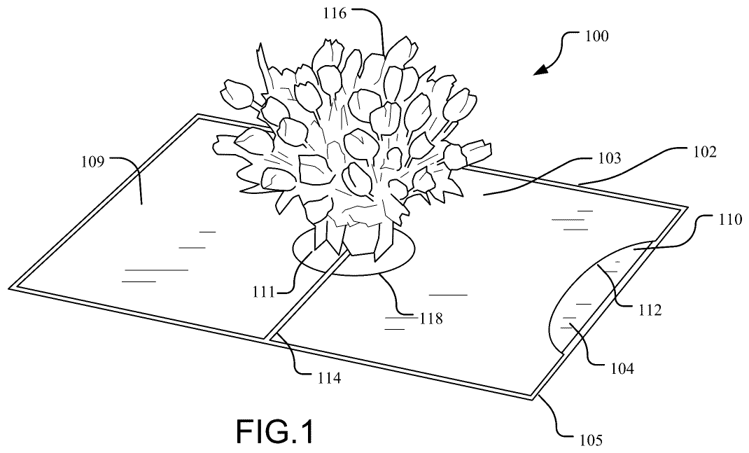

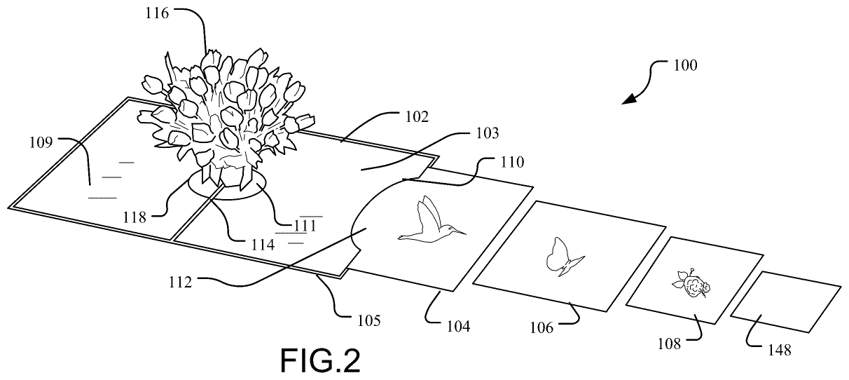

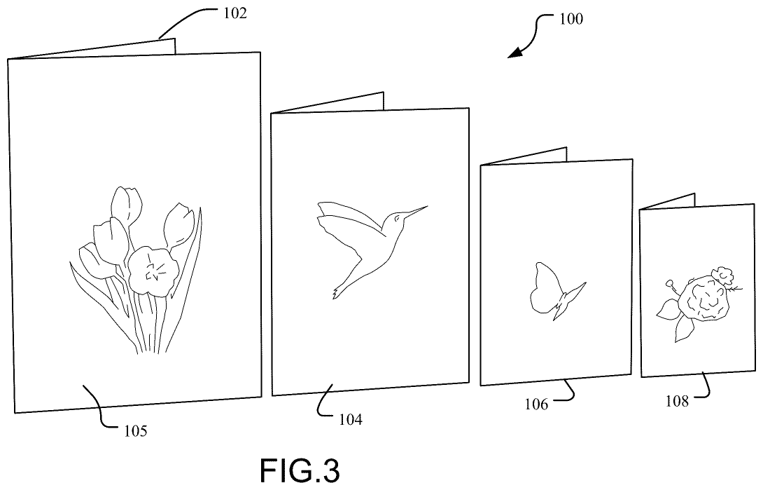

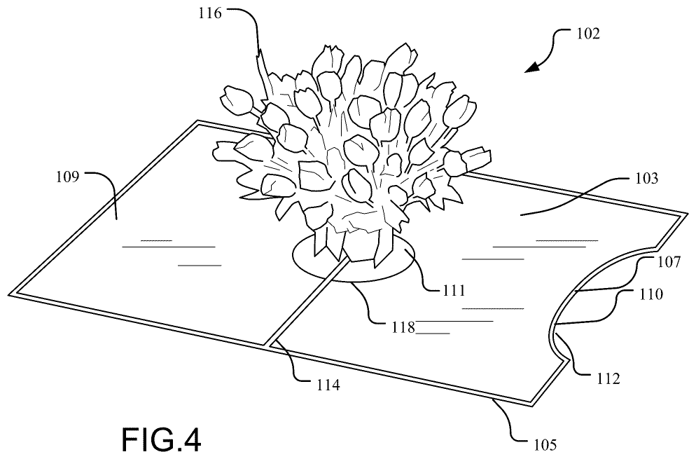

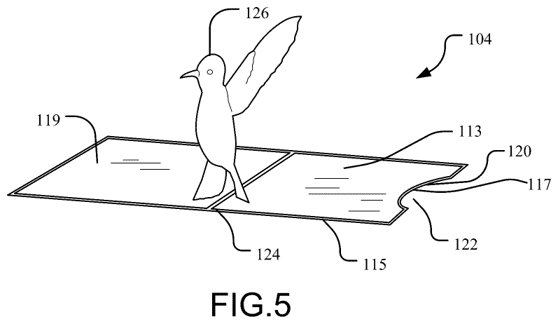

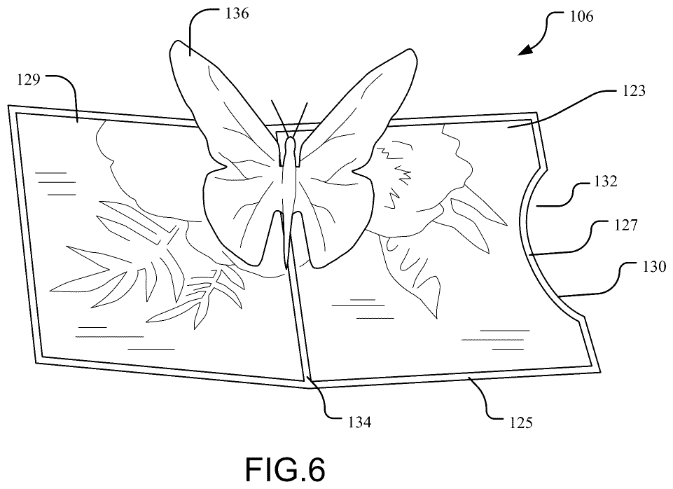

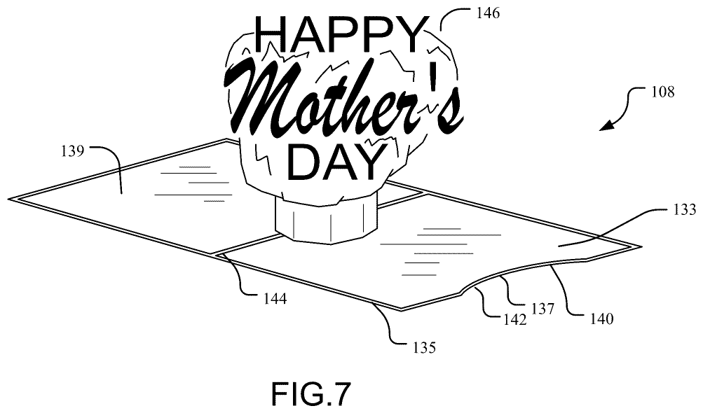

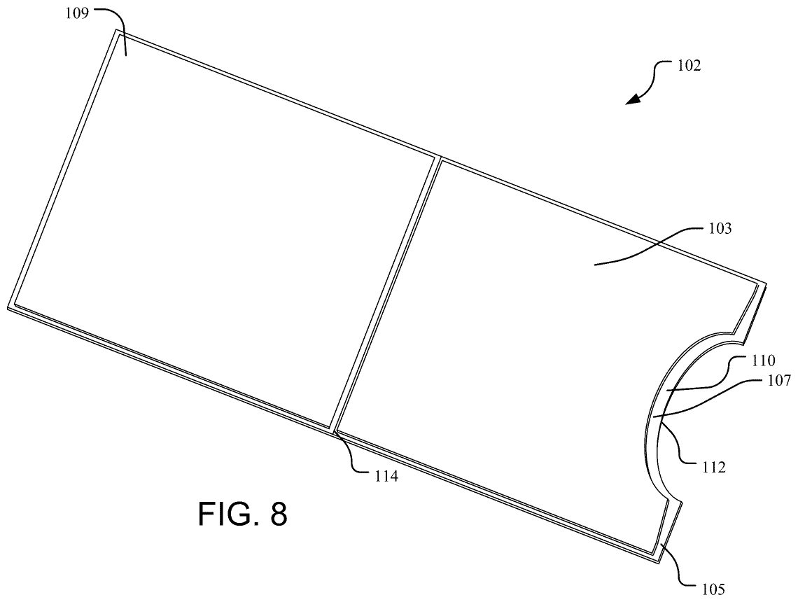

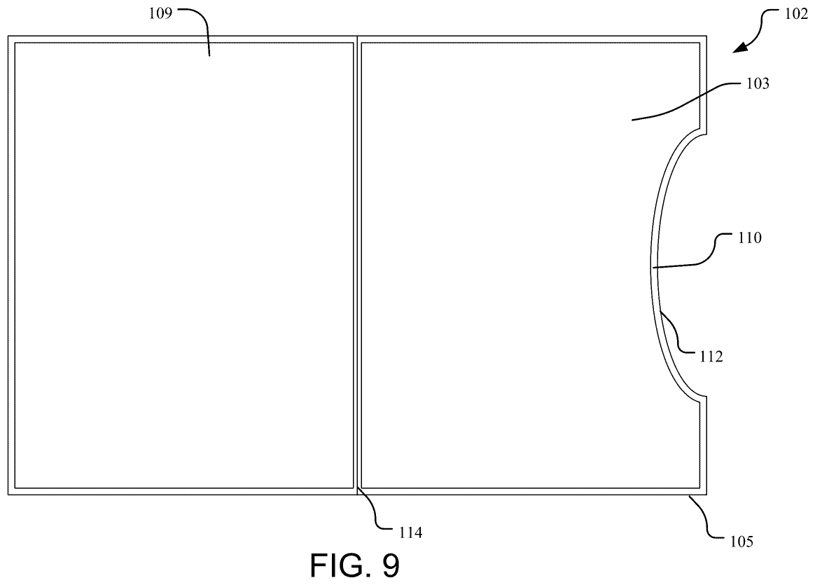

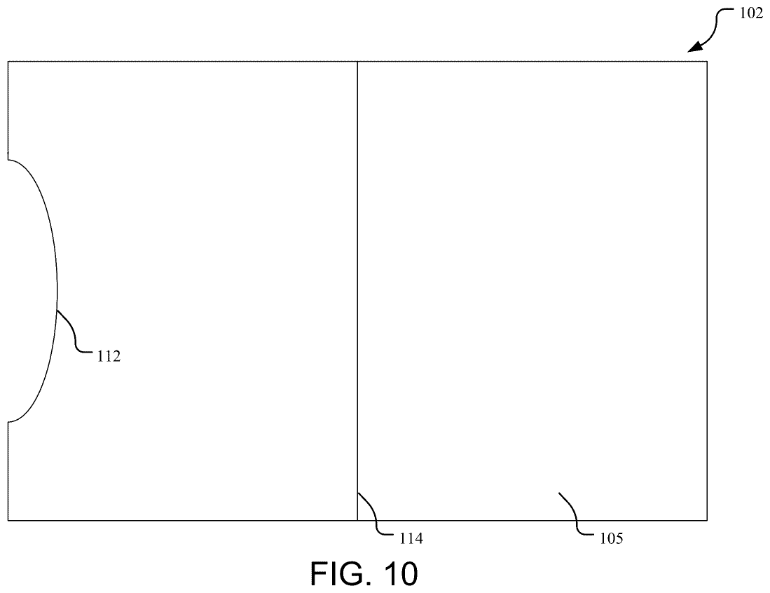

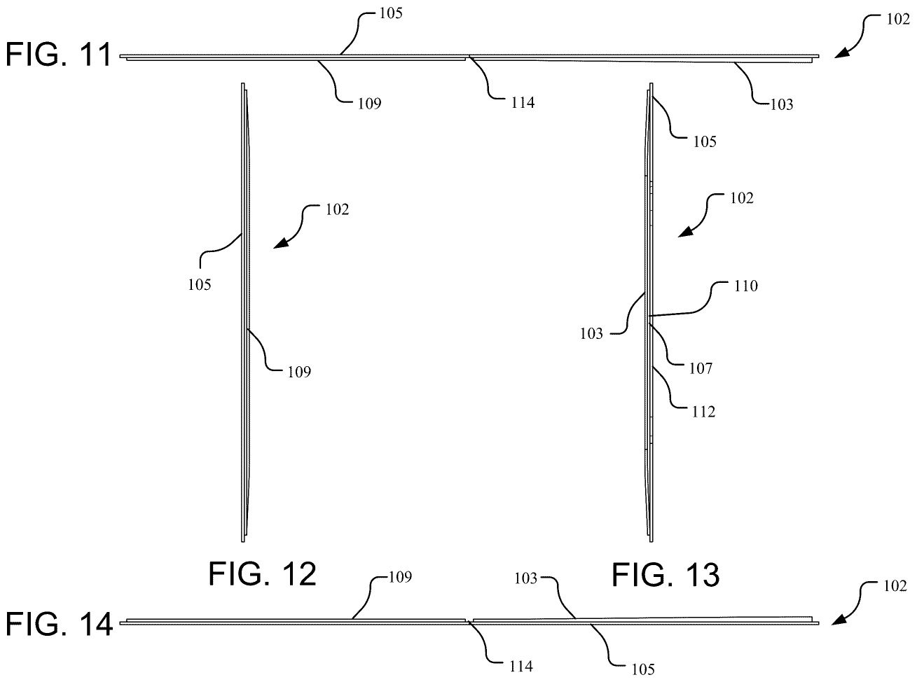

To begin a detailed description of an example card system 100, reference is made to FIGS. 1-14. In some implementations, the card system 100 includes a first card 102, a second card 104, a third card 106, and a fourth card 108. However, the present disclosure is not limited to four cards and any suitable number of cards may be used. The first card 102 may be a primary parent card, and the fourth card 108 may be a primary child card. Each of the second card 104, the third card 106, and the fourth card 108 is a child card to one or more corresponding parent cards, and each of the first card 102, the second card 104, the third card 106 is a parent to one or more corresponding cards. For example, each of the second card 104, the third card 106, and the fourth card 108 are child cards of the first card 102. The second card 104 is a parent card to the third card 106 and the fourth card 108, and the third card 106 is a parent card to the fourth card 108. The fourth card 108 may have a plurality of panels or be formed as a single panel (e.g., a notecard). Each of the plurality of cards are different sizes forming an enclosed relationship with the cards arranged as a series of enclosed assemblies in decreasing order. For example, the second card 104 is smaller than the first card 102, the third card 106 is smaller than the second card 104, and the fourth card 108 is smaller than the third card 106. In an implementation one or more of the first 102, second 104, third 106, and fourth 108 cards are 3D pop-up cards having a pop-up display. The pop-up display may include a plurality of intersecting slice-form elements.

The first card 102 includes a first panel 103 and a second panel 105. A portion of a perimeter of the first panel 103 is coupled to a corresponding portion of a perimeter of the second panel 105 to form a first card pocket 110 between the first panel 103 and the second panel 105. The first card pocket 110 includes a first card pocket opening 107 configured to receive one or more of the second 104, third 106, and fourth 108 cards, and a first card cutout 112 that allows access to the second 104, third 106, and fourth 108 cards disposed in the first card pocket 110. The first panel 103 and the second panel 105 are not coupled to each other in an area of the first card pocket opening 107 to allow one or more of the second 104, third 106, and fourth 108 cards to be inserted between the first panel 103 and the second panel 105. In some implementations, the first card 102 includes a third panel 109 coupled to the second panel 105.

The first card 102 is foldable along a first card fold line 114 to allow the first card 102 to be moveable between closed and opened positions. Although only one fold line is illustrated, the present disclosure is not limited to one fold line and any number of fold lines can be used. In an implementation, the first card 102 includes a first card decorative portion 116, which may include a pop-up display. In some implementations, the first card 102 includes a separable perforated section 118 extending over both sides of the second panel 105. The first card decorative portion 116 is incorporated into and/or mounted to the first card 102 and can be removed therefrom by separating the separable perforated section 118 from the rest of the first card 102. It will be appreciated that a pop-up display of the first card decorative portion 116 may be mounted to and/or removable from the first card 102 in a variety of manners. The first card decorative portion 116 may be an erectable pop-up display comprising a plurality of intersecting slice-form elements. The first card decorative portion may be disposed on a base 111.

In some examples, when the first card 102 is in the closed position, the first card decorative portion 116 is in a flattened state, and when the first card 102 is in the opened position, the first card decorative portion 116 is in an erected state. Although only the first card 102 is illustrated with a separable perforated section, the present disclosure is not limited as such and any of the cards 102-108 can have a separable perforated section for mounting a decorative portion thereto. Similarly, any of the cards 102-108 may have pop-up displays mounted thereto, which may be removable and/or fixed in various forms.

In some implementations, the second card 104 includes a first panel 113 and a second panel 115. A portion of a perimeter of the first panel 113 is coupled to a corresponding portion of a perimeter of the second panel 115 to form a second card pocket 120. The second card pocket 120 includes a second card pocket opening 117 configured to receive the third 106 and fourth 108 cards, and a second card cutout 122 that allows access to the third 106 and fourth 108 cards disposed in the second card pocket 120. The first panel 113 and the second panel 115 are not coupled to each other in an area of the second card pocket opening 117 to allow the third 106 and fourth 108 cards to be inserted between the first panel 113 and the second panel 115. In an implementation, the second card 104 includes a third panel 119 coupled to the second panel 115. The second card 104 is foldable along a second card fold line 124 between closed and opened positions. Although only one fold line is illustrated, the present disclosure is not limited to one fold line and any number of fold lines can be used. The second card 104 includes a second card decorative portion 126. In an implementation, the second card decorative portion 126 is an erectable pop-up display structure comprising a plurality of intersecting slice-form elements. In this implementation, when the second card 104 is in the closed position, the second card decorative portion 126 is in a flattened state, and when the second card 104 is in the opened position, the second card decorative portion 126 is in an erected state.

The third card 106 may include a first panel 123 and a second panel 125. A portion of a perimeter of the first panel 123 is coupled to a corresponding portion of a perimeter of the second panel 125 to form a third card pocket 130. The third card pocket 130 includes a third card pocket opening 127 configured to receive the fourth card 108, and a third card cutout 132 that allows access to the fourth card 108 disposed in the third card pocket 130. The first panel 123 and the second panel 125 are not coupled to each other in an area of the third card pocket opening 127 to allow the third 106 and fourth 108 cards to be inserted between the first panel 123 and the second panel 125. In an implementation, the third card 106 includes a third panel 129 coupled to the second panel 125. The third card 106 is foldable along a third card fold line 134 between closed and opened positions. Although only one fold line is illustrated, the present disclosure is not limited to one fold line and any number of fold lines can be used. The third card 106 includes a third card decorative portion 136. In some implementations, the third card decorative portion 136 is an erectable pop-up display structure comprising a plurality of intersecting slice-form elements. In this implementation, when the third card 106 is in the closed position, the third card decorative portion 136 is in a flattened state, and when the third card 106 is in the opened position, the third card decorative portion 136 is in an erected state.

In some examples, the primary child card may include one or more panels. In one example, the primary child card may be a notecard. In another example, the fourth card 108 may include a first panel 133 and a second panel 135. A portion of a perimeter of the first panel 133 is coupled to a corresponding portion of a perimeter of the second panel 135 to form a fourth card pocket 140. The fourth card pocket 140 includes a fourth card pocket opening 137 configured to receive other contents, such as a note 148, a card, and/or other objects, and a fourth card cutout 142 that allows access to the other contents disposed in the fourth card pocket 140. The first panel 133 and the second panel 135 are not coupled to each other in an area of the fourth card pocket opening 137 to allow the other contents to be inserted between the first panel 133 and the second panel 135. In an implementation, the fourth card 108 includes a fourth panel 139 coupled to the second panel 135. The fourth card 108 is foldable along a fourth card fold line 144 between closed and opened positions. Although only one fold line is illustrated, the present disclosure is not limited to one fold line and any number of fold lines can be used. The fourth card 108 includes a fourth card decorative portion 146. In an implementation, the fourth card decorative portion 146 is an erectable pop-up display structure comprising a plurality of intersecting slice-form elements. In this implementation, when the fourth card 108 is in the closed position, the fourth card decorative portion 146 is in a flattened state, and when the fourth card 108 is in the opened position, the fourth card decorative portion 146 is in an erected state.

Although the first card decorative portion 116 is illustrated as a bouquet of flowers, the second card decorative portion 126 is illustrated as a bird, the third card decorative portion 136 is illustrated as a butterfly, and the fourth card decorative portion 146 is illustrated as a word sign, the disclose sure is not limited as such, and the respective decorative portions can include various decorative features, such as, for example, imitation flowers, imitation leaves, imitation trees, imitation plants, characters, animals, insects, objects, and/or the like. In an implementation, the first 116, second 126, third 136, and fourth 146 card decorative portions are erectable pop-up display structures respectively comprising a plurality of intersecting slice-form elements, as described above. When the cards 102, 104, 106, and 108 are in a closed state, the respective pop-up display structure is in a flattened state, and when the cards 102, 104, 106, and 108 are in an opened state, the respective pop-up display structure is in an erected state.

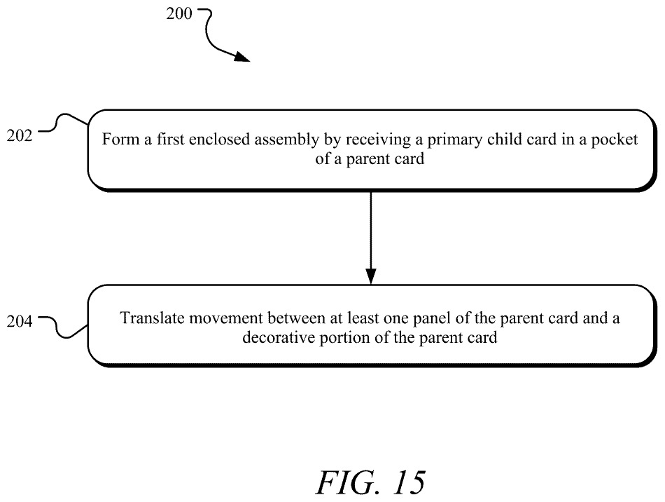

Referring to FIG. 15, a flow chart illustrates a method 200 for presenting a card system. In some implementations, an operation 202 forms a first enclosed assembly by receiving a primary child card in a pocket of a parent card. The primary child card has a first size, and the parent card has a second size. The first size is smaller than the second size. The primary child card having an enclosed relationship with the parent card. An operation 204 translates movement between at least one panel of the parent card and a decorative portion of the parent card. The decorative portion including a pop-up display. The translation of the movement between the at least one panel and the decorative portion moving the decorative portion from a flattened state to an erected state when the at least one panel moves from a closed position to an open position.

In some examples, the operations 200 may further include forming a second enclosed assembly by receiving the first enclosed assembly in a second pocket of a second parent card. The second parent card has a third size that is larger than the second size. The enclosed relationship further includes a relationship of the first enclosed assembly to the second enclosed assembly. The primary child card, the parent card, and/or the second parent card may have various features as detailed herein. The first enclosed assembly may be received in the second pocket when the parent card is disposed in the closed position and the decorative portion is in the flattened state. These operations may be repeated for additional parent cards and enclosed assemblies until a primary parent card is reached. The enclosed assembly of the parent card within the enclosed relationship may be received by an envelope.

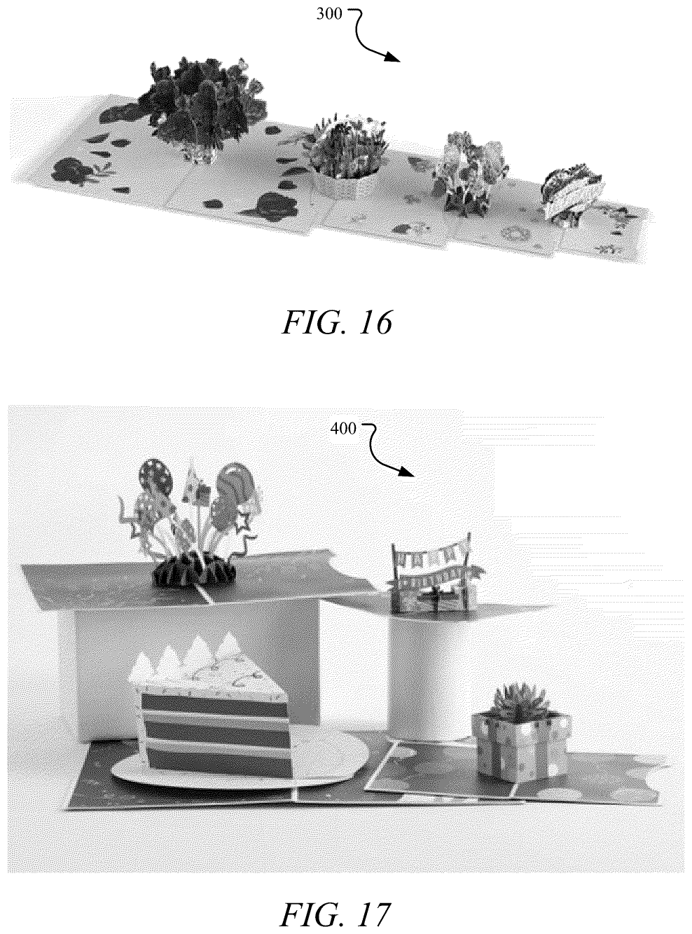

Turning to FIGS. 16-22, additional examples of a card system are illustrated, which may be substantially similar to the card system 100. As can be understood from FIG. 16, a first example card system 300 includes a set of five cards. Four of the cards shown partially removed from each other include a decorative element with a pop-up display. The pop-up display may be positioned on a fold line of a corresponding card, with the fold line separating a first panel from a second panel. In some examples, a first portion of the pop-up display is mounted to the first panel, and a second portion of the pop-up display is mounted to the second panel. In this manner, the card translates movement from at least one of the panels to the pop-up display. The pop-up display may be removable from the panels. In this example, a primary child card takes the form of a notecard, shown forming an enclosed assembly in FIG. 16.

FIG. 17 shows a second example card system 400 with other decorative portions and content. The card system 400 may be substantially similar to the card system 100 and include similar features to the card system 300. In one example, at least one of the cards may include a decorative portion disposed between a first panel and second panel. The decorative portion may include a base having a first side and a second side separated by a crease line. The base may be removably mounted to at least one of the first panel or the second panel (e.g., with the crease line parallel to a fold line separating the first panel and the second panel) or the base may be loose from the first panel and/or the second panel. The base may translate movement to a pop-up display to move the pop-up display between an erected state and a flattened state as the base moves between a closed and an open position. The base may include one or more locks to maintain the pop-up display in the erected state. The locks may be releasable.

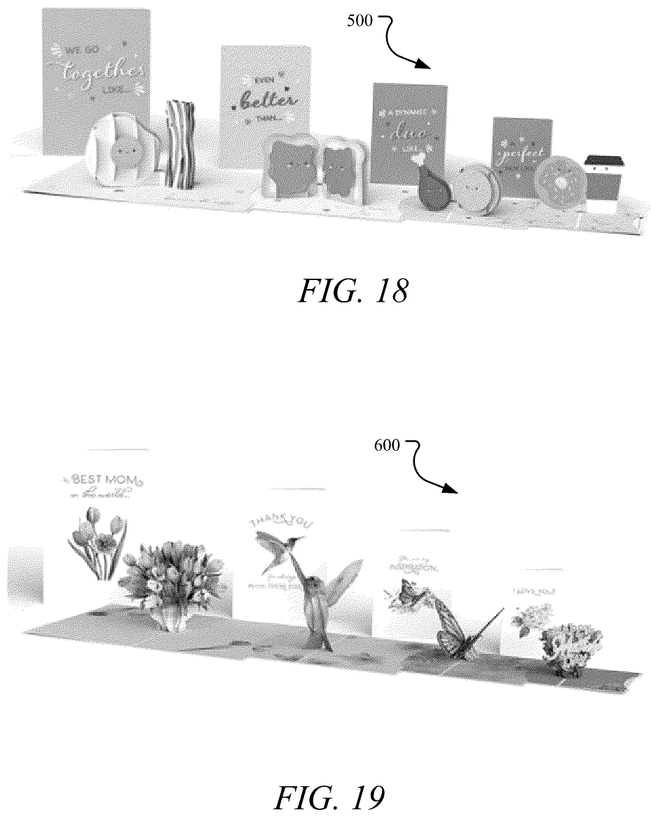

Turning to FIG. 18, a third example card system 500 with other decorative portions and content. The card system 500 may be substantially similar to the card system 100 and include similar features to the card systems 300-400. In one example, at least one of the cards includes a decorative portion including a first pop-up display and a second pop-up display. The first pop-up display may be disposed relative to a first panel of the card, and the second pop-up display may be disposed relative to a second panel of the card. The first pop-up display may be connected with or loose from the second pop-up display. The first and second pop-up displays may be translationally mounted to the first panel and/or the second panel to move each of the first and second pop-up displays between an erected state and a flattened state as the first panel and/or the second panel move between a closed position and an open position.

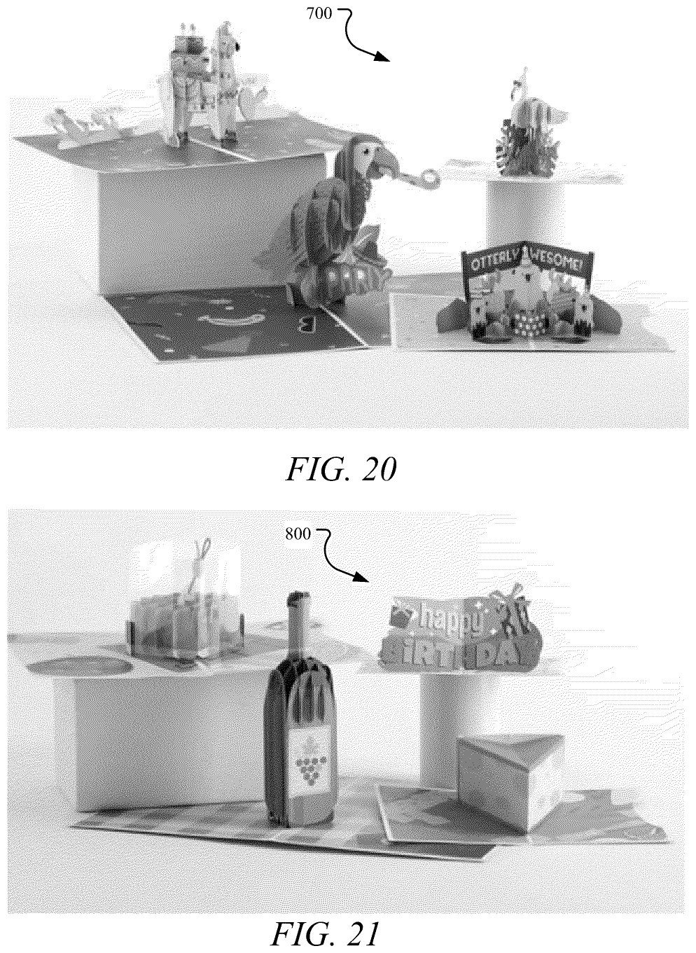

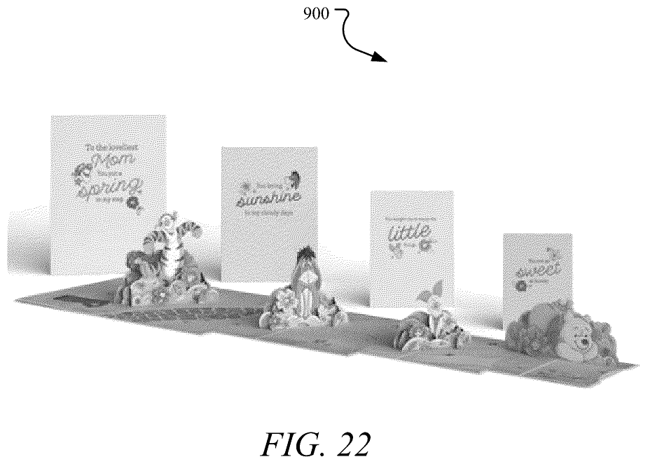

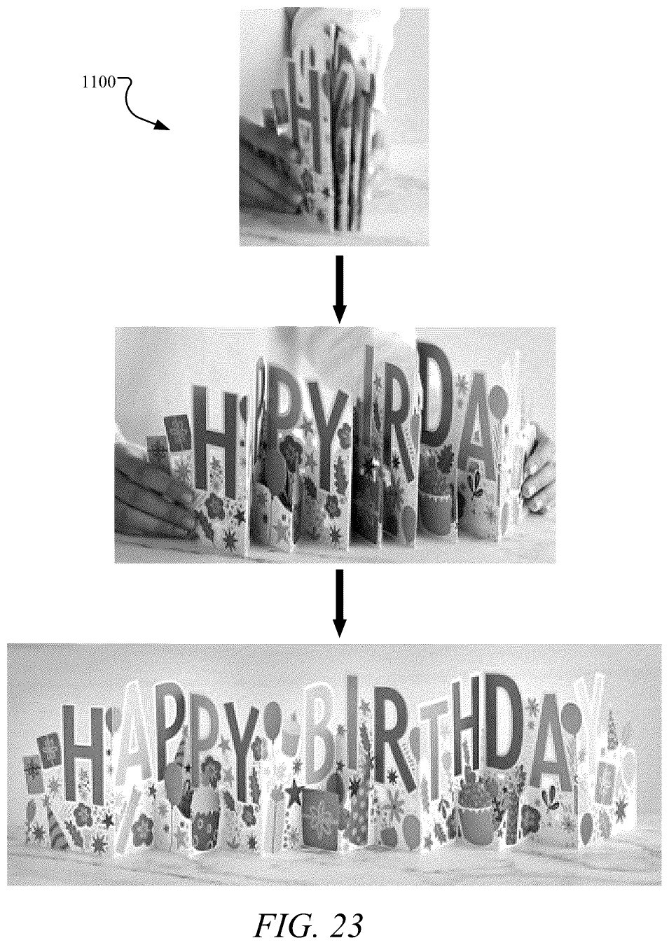

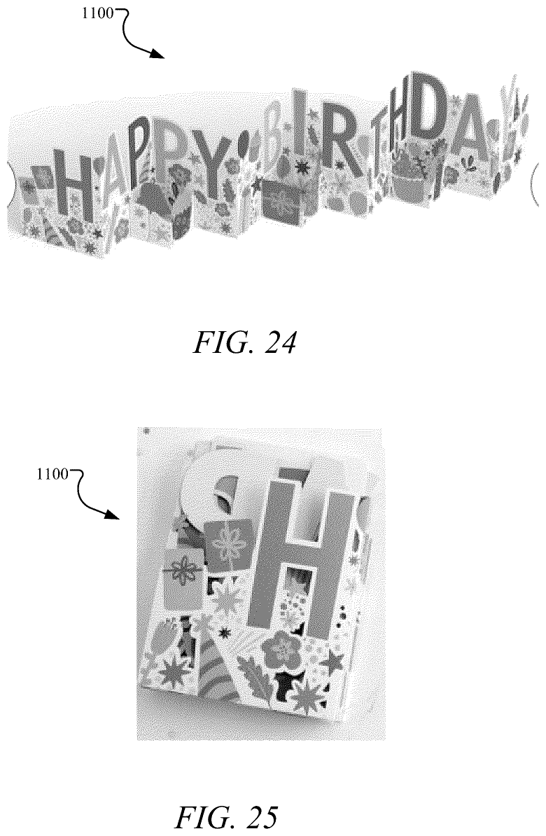

FIGS. 19-20 show a fourth example card system 600 and a fifth example card system 700, respectively, with other decorative portions and content. The card systems 600-700 may be substantially similar to the card system 100 and include similar features to the card systems 300-500. As shown, one or more of the cards may include a decorative portion with one or more pop-up displays formed by intersecting slice-form elements. Further, as can be understood by a sixth example card system 800 and a seventh example card system 900 shown in FIGS. 21-22, the cards within a card system may include different and/or similar types of decorative elements from each other. For example, the decorative portions may include various combinations of slice-form elements, one or more panels with moveable relationships that move and/or fold relative to each other and/or panels of the card as the card moves between an open position and a closed position. For example, a pop-up display may include a first point mounted to a card fold line separating a first card panel and a second card panel. A second point of the pop-up display may be mounted to the first card panel, and a third point may be mounted to the second card panel. In an erected state, the pop-up display includes a first display panel extending between the first point and the second point, a second display panel extending between the first point and the third point, and a third display panel extending between the second point and the third point. A top panel may extend from the first display panel and the second display panel and include a panel crease line extending parallel with the card fold line in the erected state. The third display panel may have a second panel crease line extending from the card fold line towards the top panel in the erected state. As the card moves from the open position to the closed position, the pop-up display folds along the panel crease line and the third display panel extends over the top panel, such that the panel crease line and the second panel crease line extend over each other in a same direction. In the flattened state, the third display panel and the top panel are sandwiched between the first display panel and the second display panel.

Turning to FIGS. 23-25, a card system 1100 is illustrated. In some implementations, the card system 1100 includes an elongated card body having a first side disposed opposite a second side. The card system further includes a distal edge extending along a length of the elongated card body. The elongated card body includes a plurality of fold lines. The elongated card body may include a plurality of panels, with each fold line formed by a connection between a first panel and a second panel, and/or the elongated card body may include the fold lines integrated into the elongated card body. Each of the plurality of fold lines extends in a direction transverse to the distal edge.

The plurality of fold lines form a series of first panels and a series of second panels. The fold lines translate movement between the series of first panels and the series of second panels to move the elongated card body between a folded position and an unfolded position. In this manner, a first end panel may receive a pulling force relative to a second end panel, which causes the elongated card body to move from the folded position to the unfolded position, and similarly, the first end panel may receive a pushing force relative to the second end panel, causing the elongated card body to move from the unfolded position to the folded position.

In the unfolded position, the plurality of fold lines creates a first plurality of peaks and a second plurality of peaks between the series of first panels and the series of second panels. The first and second plurality of peaks arrange the series of first panels in a first direction and the series of second panels in a second direction. The first direction of each of the series of first panels thereby intersects the second direction of each of the series of second panels at a first corresponding peak of the first plurality of peaks and a second corresponding peak of the second plurality of peaks. Such a peaked relationship of the first series of panels and the second series of panels in the unfolded position of the elongated card body configures the distal edge of the elongated card body to form an angled shape. The angled shape includes the first plurality of peaks to extend along a first axis and the second plurality of peaks to extend along a second axis. Using the angled shape of the distal edge, the elongated card body is configured to stand in an upright position with a plane of the distal edge meeting a surface plane of a surface. In the upright position, the elongated body extends along the length of the body in the peaked relationship, with each panel of the elongated body extending in a direction away from and/or transverse to the plane of the distal edge.

In the folded position, each of the second panels in the series of second panels is positioned adjacent to and extending in a same direction as a corresponding first panel in the series of first panels, such that each of the first and second panels extend between a corresponding first peak and a corresponding second peak in a same direction. Each of the first and second panels are sandwiched between the first end panel and the second end panel in the folded position.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A card system comprising:
a child card having at least one child card panel;
a parent card having a first side;
a second side of the parent card, the second side separated from the first side by a fold line; and
a pocket formed in the first side of the parent card, the child card receivable into the pocket of the parent card in an enclosed relationship, the enclosed relationship including an entirety of the child card disposed within the pocket of the parent card as an enclosed assembly.

2. The card system of claim 1, further comprising:
a second parent card having a second pocket, the enclosed relationship further including the enclosed assembly received in the second pocket as a second enclosed assembly.

3. The card system of claim 2, wherein the child card has a first size, the parent card has a second size, and the second parent card has a third size, the first size being smaller than the second size, and the second size being smaller than the third size.

4. The card system of claim 1, further comprising:
a decorative portion disposed between the first side and the second side, the decorative portion including a pop-up display configured to move between a flattened state and an erected state as the parent card moves between a folded position and unfolded position.

5. A card system comprising:
a primary child card;
a primary parent card;
at least one parent card; and
a pocket formed in the primary parent card, an enclosed assembly receivable into the pocket of the primary parent card in an enclosed relationship, the enclosed assembly including the primary child card and the at least one parent card.

6. The card system of claim 5, wherein the enclosed relationship includes the primary child card received into a second pocket of a corresponding parent card of the at least one parent card in a second enclosed assembly.

7. The card system of claim 6, wherein the enclosed assembly has a first size and the second enclosed assembly has a second size, the first size being larger than the second size.

8. The card system of claim 5, wherein an entirety of the enclosed assembly is disposed within the pocket.

9. The card system of claim 5, wherein the at least one parent card includes a plurality of parent cards, and the enclosed relationship includes the plurality of parent cards forming a series of enclosed assemblies according to a descending order in size.

10. The card system of claim 5, wherein the at least one parent card includes a first parent card and a second parent card, the second parent card having a parent relationship with the primary child card and a child relationship with the first parent card, the first parent card having a child relationship with the primary parent card.
